(19) United States
(12) Patent Application Publication
(10) Pub. No.: US 2010/0190648 A1
(43) Pub. Date: Jul. 29, 2010

(54) Structured Agrochemical Oil Based Systems

(75) Inventors: Peter James Tollington, Rotterdam (NL); Frederico Irou Roschzttardtz, Leeds (GB); Remco Benjamin van Triet, Reeuwijk (NL); Eric Appelman, Dordrechrt (NL); Hendrik Leendert Rieffe, Gouda (NL)

Correspondence Address: JONES DAY, 222 EAST 41ST ST, NEW YORK, NY, 10017, US

(73) Assignee: Croda International PLC, Goole, North Humberside (GB)

(21) Appl. No.: 12/227,429

(22) PCT Filed: May 18, 2007
(86) PCT No.: PCT/GB2007/001830

§ 371 Date: Apr. 6, 2010

(30) Foreign Application Priority Data
May 19, 2006 (GB) 0610001.0

(51) Int. Cl. A01N 25/00; A01N 43/70; A01N 37/22; A01N 25/10; A01N 43/50; A01N 37/34; A01P 13/00; A01P 3/00; A01P 21/00

(52) U.S. Cl. 504/234; 504/342; 504/360; 514/391; 514/525; 514/772.3

(57) ABSTRACT

Structured agrochemical concentrates comprise agrochemical actives dispersed in a structured oil system of an oil and structurant oligomer including urethane and/or urea linkages and residues of a dimer or trimer component. The concentrate formulations may contain other components such as surfactants without the structurant loosing its effect a problem with known structurants. The concentrates can be readily diluted to give sprayable agrochemical formulations.

This invention relates to structured agrochemical oil based systems, in particular to such systems using structurants which are oligomers including urethane and/or urea linkages, especially oligomers derived from dimer based feedstocks, and to agrochemical formulations, based on structured oil based systems.

Oil based agrochemical concentrates are used for agrochemical actives that are insoluble in the oil (and usually also insoluble in water or other commonly used solvents). Commonly such oil based systems incorporate the agrochemical active as a dispersion of solid particles in the oil which typically further includes surfactants to facilitate emulsion formation on dilution in water for spraying and/or to improve the dispersion of the solid active in the oil. Commonly such concentrate formulations are referred to as oil dispersions or “OD” formulations, but are also known as “oil flowable”, “oil concentrate”, “oil suspension concentrate” and “non-aqueous suspension concentrate” formulations. In OD formulations, it is desirable to reduce the tendency of the solid active to separate from the oil, particularly arising from density differences between active and oil. One way of reducing separation is to include a structurant in the oil phase. The structure in the oil phase typically helps resist the separating force of gravity effects on the formulation.

Current methods of providing structure in OD formulations include the use of synthetic or natural, commonly modified natural, silicates, such as clays, for example Englehard's Attagel 50 (an attapulgite clay), and organic materials typically based on castor oil or derivatives of castor oil, e.g. as described in US 2005233906 and EP 1571908A. However, using such structurants has the difficulty that the inclusion of surfactants, particularly anionic surfactants such as calcium dodecylbenzeriesulfonates (commonly used to provide ready emulsification of the concentrate in agrochemical formulations), tends to break down the structuring and reduce the stability of the dispersion.

We have found that the use of oligomers derived from dimer based feedstocks which include urethane and/or urea linkages can provide structured products what are clear, can suspend a high concentration of solids, retaining good stability at low addition levels and over a wide temperature range, with good tolerance for other components such as surfactants, dispersants, electrolytes and low molecular weight organic components such as alcohols. It is a further advantage that the oligomeric structurants can be made without using organic solvents which would be carried over into the agrochemical formulations.

The present invention accordingly provides an agrochemical concentrate which comprises an agrochemically active component dispersed in a structured oil system which comprises an oil and including as a structurant an oligomer including urethane and/or urea linkages and residues of a dimer and/or trimer component.

Desirably the structured oil system of the invention uses oligomeric structurants which include a dimer component unit of the formula (I):

—(X)-(D)-(X)CO—NH—R¹— (I)

where
-(D)- is a difunctional residue which is or includes fatty acid dimer residues;
each X is independently —O— or —NH—, though usually the X groups are either both —O— or both —NH—; and
R¹ is a C₁ to C₆₀, particularly a C₂ to C₄₄ hydrocarbylene group.

More usually, the oligomeric structurant compounds used in the invention include repeat units of the formula (Ia):

—(X)-(D)-(X)C(O)NH—R¹—NHC(O)— (Ia)

where D, R¹ and each (X) are independently as defined for formula (I). In particular, repeat unit in the oligomers used in the invention can be urethane repeat units of the formula (Ib):

—O-(D)-OC(O)NH—R¹—NHC(O)— (Ib)

where D and R¹ are independently as defined for formula (I),
or urea repeat units of the formula (Ic):

—NH-(D)-NHC(O)NH—R¹—NHC(O)— (Ic)

where D and R¹ are independently as defined for formula (I).

Thus the overall oligomer can be of the formula (II):

R²—[(X)-(D)-(X)OCNH—R¹—NHCO]ₘ—(X)-(D)-(X)—R² (II)

where R¹, (X) and -(D)- are each independently as defined for formula (I);
each R² is independently H,
a group —C(O)R³, where R³ is a hydrocarbyl group, particularly a C₁ to C₆₀, more usually a C₁ to C₄₄, especially alkyl, group, or
   a group —C(O)NH—R¹—NHC(O)—(X)—R⁴; or
   a group —C(O)NH—R⁴; or
      the group —(X)R² is a group —O(AO)ₙ—(CO)ₚR⁴, where each OA is independently an ethyleneoxy or
   propyleneoxy group, n is from 1 to 50, p is 0 or 1;
   where each R¹ and X are independently as defined above and each R⁴ is independently a hydrocarbyl group, particularly a C₁ to C₆₀, more usually a C₁ to C₄₄, especially alkyl, group; and
      m is from 1 to 25.

Within this formula, desirable polyurethane oligomers have the formula (IIa):

R^{2a}-(X^{a})-[(D^{a})-O₂CNH—R^{1a}—NHCO₂]ₘ₁-(D^{a})-(X^{a})—R^{2a} (IIa)

where
R^{1a} is independently as defined for R¹ in formula (I);
each -(D^{a})- is independently the residue of a diol which is or includes fatty acid dimer diol residues;
each R^{2a} is independently as defined for R² in formula (II);
each X^{a} is independently as defined for X in formula (II); and
m1 is an average value of from 1 to 25,
and desirable polyurea oligomers have the formula (IIb):

R^{2b}—(X^{b})-[(D^{b})-NHCONH—R^{1b}—NHCONH-]ₘ₂-(D^{b})-(X^{b})—R^{2b} (IIb)

where
R^{1b} is independently as defined for R¹ in formula (I);
each -(D^{b})- is independently the residue of a diamine which is or includes fatty acid dimer diamine residues;
each R^{2b} is independently as defined for R² in formula (II);
each X^{b} is independently as defined for in formula (II); and
m2 is an average value of from 1 to 25.

When the structured oil system of the invention uses oligomeric structurants which include a trimer component, the trimer component will usually include a unit of the formula (III):

—(X′)₂-(T)-(X′)CO—NH—R¹⁰— (III)

where
-(T)- is a trifunctional residue which is or includes fatty acid trimer residues;
each X′ is independently —O— or —NH—, though within any component unit the X groups will usually be all either —O— or —NH—; and
R¹⁰ is independently a group as defined for R¹.

In particular trimer derived units within the formula (III) will be based on trimer triol and/or trimer triamine component units and the corresponding repeat units may be of the formula (IIIa):

—(X′)-(T)(X′R¹¹)—(X)C(O)NH—R¹⁰—NHC(O)— (IIIa)

where T, R¹⁰ and each X′ are independently as defined for formula (III) and
R¹¹ is H, or (more usually) a group —C(O)NH—R¹², or a group —C(O)NH—R¹³—NHC(O)— (forming a third link as part of the repeat unit);
   where
   R¹² is a hydrocarbyl group, particularly a C₁ to C₆₀, more usually a C₁ to C₄₄, especially alkyl, group; and
   R¹³ is a group as defined for R¹⁰ in formula (III).

In particular, repeat unit in the oligomers used in the invention can be urethane repeat units of the formula (IIIb):

—O-(T)(OR¹¹)—OC(O)NH—R¹⁰—NHC(O)— (IIIb)

or urea repeat units of the formula (IIIc):

—NH-(T)(OR¹¹)—NHC(O)NH—R¹⁰—NHC(O)— (IIIc)

where T, R¹⁰ and R¹¹ are independently as defined for formula (III) or (IIIa).

Oligomers used in the invention may include both dimer containing and trimer containing units (see also below on the dimer/trimer source materials).

The dimer and/or trimer units in the structurants used in the invention may be provided as residues of dimer and/or trimer acids respectively reacted with hydroxyl or amine ended oligourethane or oligourea units, for example as the products of chain extension reactions. In such cases dimer component units may be of the formula (IV):

—(OC)-(D′)-(COX″)—R²⁰— (IV)

where
D′ is the residue of a dimer acid less the (two) carboxyl groups;
each r is independently —O— or —NH—, though within any component unit the X groups will usually be all either —O— or —NH—; and
R²⁰ is the residue of a urethane or urea oligomer,
and dimer containing repeat units may be of the formula (IVa):

—(OC)-(D′)-(COX″)—R²⁰—(X″)— (IVa)

where D′, each X″ and R²⁰ are independently as defined for formula (IV).

Correspondingly trimer containing units may be of the formula (V):

—(X″C(O))₂-(T′)-(COX″)—R²⁰— (V)

where each X″ and R²⁰ are independently as defined for formula (IV) and T′ is the residue of a trimer acid less the (three) carboxyl groups,
and trimer containing repeat units may be of the formula (Va):

—(X″C(O))-(T′)(COX″R²¹)—(C(O)X″)R²⁰— (Va)

where D′, X″ and R²⁰ are as defined for formula (IV), and
R²¹ is H, or (more usually) a group —C(O)X″—R²², or a group —C(O)X″—R²³—X″C(O)— (forming a third link as part of the repeat unit);
   where each X″ is independently as defined for formula (IV);
   R²² is a hydrocarbyl group, particularly a C₁ to C₆₀, more usually a C₁ to C₄₄, especially alkyl, group; and
   R²³ is a group as defined for R¹⁰ in formula (III).

Although in such oligomers the oligourethane or oligourea units may include no such dimer or trimer residues, it is desirable that they do contain dimer and/or trimer residues (and will thus also fall within formula (II) above).

The oligomers can include mixed urethane and urea repeat units either by using a mixture of hydroxyl—diol or triol—and amine—diamine or triamine—or by including a hydroxy amine in the synthesis (see further below) and the end group (where it is other than H) can be linked by ester, urea or urethane links depending on whether the oligomer is hydroxyl, amine or isocyanate ended and correspondingly by using an alcohol, amine, isocyanate or fatty acid (or suitably reactive derivative) to provide the end group functionality.

The term “structurant” describes a material which provides structure in the oil based formulations of the invention which improves the stability of the dispersion of the agrochemical active. Correspondingly in describing oil phases as “structured” we mean that solids dispersed in a structured oil phase show a much lower tendency to settle or segregate from the oil continuous phase than in the absence of the structurant. Generally the structure is provided by gelling the oil phase and it is usually possible to measure the yield stress of the gelled oils. The yield stress enables the gelled oil to provide support for dispersed agrochemical active thus stabilising the dispersions, with the suspended solids showing a reduced tendency to settle out of suspension or separate from the oil phase. It is possible (see further below) for the gel to be “amorphous” in which case it will not generally show a well defined yield stress, but it rheological properties provide support for the dispersed agrochemical. Generally, the structured oil based formulations of the invention show strongly shear thinning properties even at relatively low shear rates and this aids pouring or pumping of the structured oil based concentrate and its dilution in water.

Oil dispersion agrochemical formulations, also known as “oil flowable”, “oil concentrate”, “oil suspension concentrate” and “non-aqueous suspension concentrate formulations, are concentrate formulations in which the agrochemical active is dispersed as solid particles in an oil phase. In this context the term oil is used to cover agrochemically acceptable non-aqueous organic liquids used as dispersion carrier fluids in such formulations. Many of these will be immiscible with water and conventionally regarded as “oils” e.g. mineral and other hydrocarbon oils and ester oils, some may be water miscible e.g. lower alkanols, or hydroxylic e.g. fatty alcohols, glycols or liquid polyols, or otherwise may not usually be thought of as oils. The term “oil” is used for such carrier fluids as a convenient term. Generally oil dispersion formulations are made so that they emulsify readily on dilution with water, desirably with just the agitation required to dilute the formulation.

The products used in this invention are oligomers and/or oligomers which may have varying repeat units. For convenience the term oligomer is used to refer to such materials irrespective of the number of repeat units or molecular weight of the materials concerned.

The group -(D)- is a difunctional residue which is or includes residues based on fatty acid dimer residues. Fatty acid dimers (more commonly referred to simply as “dimer acids”) are the well known mainly dimeric oligomerisation products derived from unsaturated fatty acids (industrially principally oleic, linoleic and/or linolenic acids), typically thermally oligomerised using clay catalysts. Generally they have average molecular weights corresponding to approximately two molecules of the starting fatty acid, so dimerised oleic acid has an average molecular weight corresponding to a nominally C₃₈ diacid. As manufactured, dimer acids have unsaturation, typically corresponding to 1 or 2 ethylenic double bonds per molecule, but this may be reduced (hydrogenated) in making starting materials for the oligomers used in this invention.

The dimer derived starting materials will typically be either a dimer diol or a dimer diamine (or a mixture of these) (but see also below for description of chain extenders including dimer components). Dimer diols are the dihydroxy alcohols obtained by reducing or hydrogenating a dimer acid derivative, usually the methyl ester, to the dimer diol or by dimerisation of a corresponding unsaturated fatty alcohol. Dimer diamines are commercially made by nitrilation of the fatty acid e.g. with ammonia, followed by hydrogenation. For dimer derived residues, the group (D) will typically be either the residue of a dimer diol of the formula (IIIa) HO-(D)-OH, or a dimer diamine of the formula (IIIb) H₂N-(D)-NH₂, i.e. after removal of the diol hydroxyl or diamine amino groups. Hydroxyl ended dimer components may also be provided by using hydroxyl ended dimer acid oliogoesters with diols.

Dimer acids are commercially made as distillation fractions from the oligomerisation reaction described above and typically will include small proportions of monocarboxytic and tricarboxylic materials. The proportion of such monofunctional material is desirably kept relatively low as such compounds will give will tend to act as chain stoppers in the urethane or urea oligomers. Generally the proportion of residues of such monofunctional hydroxyl or amino compounds in the material used to make the oligomer will not be more than about 6 wt %, more usually not more than about 3 wt %, and desirably not more than about 1 wt %, of the total diol or diamine residues used. Amounts from 0.5 to 3 wt %, more usually 1 to 2 wt %, of the total diol or diamine residues used are typical.

Trifunctional hydroxyl or amino compounds may be present in dimer acids and their derivatives used in this invention and such compounds will typically be incorporated into the oligomers and may give rise to branched oligomers. The proportion of residues of such trifunctional hydroxyl or amino compounds in the material used to make the oligomers used in the invention will not generally be more than about 80 wt %, more usually not more than about 25 wt %, and desirably not more than about 3 wt %, of the total diol or diamine residues used. Amounts from 0 to 2 wt %, of the total diol or diamine residues used are typical.

For oil flowable agrochemical formulations it is unlikely that it will be desired to deliberately crosslink the structurant polymers to a major extent as this would be likely to reduce the flowability of the formulations. However, relatively low levels of cross-linking can give useful improvements in the gel properties of the structurant polymers, for example improved thermal stability, reduced bleeding (syneresis) in formulations, and better oil solubility. This can be achieved by adding tri- and/or higher functional monomer components as starting materials or by using excess diisocyanate in the polymer forming reaction; the excess diisocyanate can catalytically react to form allophanate (with urethane groups) and/or biuret (with urea groups) linkages. Suitable catalysts for this include stannous octanoate, potassium carbonate and triethylamine. However, excessive polymer cross-linking leads to undesirable thermal irreversibility, reduced oil or solvent solubility and poor physical handling properties. The amount of the cross-linking monomer(s) added (or excess diisocyanate used) will generally be relatively small, typically not more than about 10 mole % and desirably not more than about 3 wt %, of the total diol or diamine residues used.

Other difunctional compounds can be substituted for part of the dimer diol or diamine to modify the effect of the oligomer on the properties of the oil system, for example to vary the gel strength or improve the thermal stability i.e. increase the temperature at which the gel softens or melts.

Suitable such diols include alkane diols, e.g. 2 ethylhexane-1,3 diol, αω-alkane diols such as ethylene glycol, 1,3-propane diol and 1,4-butane diol, neopentyl glycol (2,2-dimethylpropane-1,3-diol), 1,6-hexane diol and 1,10-decane diol, polyalkylene glycols particularly those made using ethylene, propylene or butylene oxide, predominantly hydroxyl ended polyester polyol oligomers of dicarboxylic acids, such as adipic, azeleic, sebacic and dimer acids and their mixtures, and diols, such as those set out above (including dimer diols), partial fatty esters of polyols in which polyols such as glycerol, trimethylolpropane, sorbitol sorbitan, polyglycerol, pentaerithrytol and their alkoxylated versions, are esterified with fatty acids to give an average hydroxyl functionality close to 2, or such that two hydroxyl groups on the ester are substantially more reactive and fatty acids esters in which the fatty acids contributes hydroxyl functionality, such as glycol and polyol esters of ricinoleic acid, 12-hydroystearic acid and 9,10-dihyroxystearic acid. Diols from alkoxylation of ammonia, such as diethanolamine, or hydrocarbyl, particularly alkyl, especially fatty alkyl, amines such as laurylamine and diol derivatives of epoxidised oils and fats may also be used.

Using such polymeric diols it is possible to control the molecular weight and relative hydrophobicity of the diol so it can be chosen to be similar or different to the dimer diol units. This may enable more subtle adjustment of the structuring effect of the oligomer on the oil system. When used, such other diols will generally be from 1 to 75 wt %, more usually from 3 to 50 wt %, and desirably from 5 to 20 wt %, of the total diol residues used. Correspondingly the proportion of dimer diol residues used will generally be from 25 to 99 wt %, more usually from 50 to 97 wt %, and desirably from 80 to 95 wt %, of the total diol residues used.

Amines that can substitute for dimer diamine include hydrocarbyl diamines particularly alkylene diamines such as ethylenediamine, 1,2- and 1,3-diaminopropane, 1,4-diaminobutane, 1,2-diamino-2-methylpropane, 1,3- and 1,5-diaminopentane, 2,2-dimethyl-1,3-propanediamine, 1,6-hexane-diamine (hexamethylenediamine), 2-methyl-1,5-pentanediamine, 1,7-diaminoheptane, 1,8-diamino-octane, 2,5-dimethyl-2,5-hexanediamine, 1,9-diaminononane, 1,10-diaminodecane and 1,12-diaminododecane, cyclic hydrocarbyl amines such as 4,4′-methylenebis(cyclohexylamine), 1,3-cyclohexanebis(methylamine), adamantane diamine and 1,8-diamino-p-menthane, aromatic diamines such as 1,2-, 1,3- and/or 1,4-phenylene diamine, 2,4,6-trimethyl-1,3-phenylenediamine, 2,3,5,6-tetramethyl-1,4-phenylenediamine, xylene and naphthalene diamine (all isomers), diaminophenanthrene (all isomers, including 9,10), 2,7-diaminofluorene, diaminonaphthalene (all isomers, including 1,5; 1,8; and 2,3) and cyclic amines such as 4-amino-2,2,6,6-tetramethyl-piperidine. Such diamines may include hetero- e.g. oxygen, atoms particularly in alkyleneoxy residues. Examples of such materials include the so-called Jeffamine diamines (poly(alkyleneoxy)-diamines from Texaco). The diamines may include further nitrogen atoms as in polyalkylene amines, which are typically of the formula: NH₂—(CH₂CH₂NH)ₘCH₂CH₂—NH₂, where m is from 1 to about 5 and examples include diethylenetriamine and triethylenetetramine. The further nitrogen atoms may also be present as tertiary nitrogen atoms in particular as hetero-atoms in a cyclic group as in bis(aminoethyl)-N,N′-piperazine and bis(aminopropyl)—N,N′-piperazine. Such diamines may have one primary amine group and one secondary amine group as in N-ethylethylenediamine or 1-(2-aminoethyl)piperazine.

Generally when such modifying diamines are included the amounts will be relatively small as the diamines will react to give (bis)-urea linkages that will lead to stiffer chains and the polymers will usually have higher melting temperatures. When used, such other diamines will generally be from 1 to 20 wt %, more usually from 1 to 15 wt %, and desirably from 1 to 10 wt %, of the total diamine residues used. Correspondingly the proportion of dimer diamine residues used will generally be from 80 to 99 wt %, more usually from 85 to 99 wt %, and desirably from 90 to 99 wt %, of the total diamine residues used.

It is possible to include materials that provide both amino and hydroxyl functionality, which will generate both urethane and urea linkages in the product oligomer and examples include mono- and di-ethanolamine and propanolamine, 2-amino-2-methyl-1-propanol, 2-amino-1-butanol, 4-amino-1-butanol, 2-amino-2-ethyl-1,3-propa nediol, AMPD(2-amino-2-methyl-1,3-propanediol), 2-amino-2-methyl-1,3-propanediol, and 2-amino-2-hydroxymethyl-1,3-propane-diol.

It is also possible, though not particularly desired to combine such other diols with dimer diamine and other amines with dimer diol to give mixed urethane/urea oligomers.

Tri- and higher functional hydroxyl and/or amino functional components can be included in the reagents used to make the structurant oligomers. Generally the proportions used will be small e.g. similar to the amounts of non-dimer amines (see above), and mono- or di-functional hydroxy or amino functional (or additional monocarboxylic functional) components may be included to act as chain stoppers to control the overall molecular weight and/or the extent of branching and/or crosslinking to avoid producing intractable and/or oil insoluble oligomers/polymers.

Chain extension reactions are briefly mentioned above as a way of making oligomeric structurants useful in the present invention, particularly by using multifunctional reagents to link together smaller oligomer units with possible subsequent reaction to end-cap the products. The chain extension reactions can form urethane/urea linkages, for example by reaction of hydroxyl/amine ended oligomer units with isocyanate chain extenders, or of isocyanate ended oligomer units with hydroxyl/amine ended chain extenders; or ester or amide linkages for example by reaction of hydroxyl/amine ended oligomer units with carboxyl ended chain extenders. The oligomer units used in this approach to the synthesis of oligomeric structurants, are urethane and/or urea linked oligomers made from suitable monomer materials such as those described above. The oligomer units can, and usually will, include dimer and/or trimer component residues, in which case the chain extender(s) can be di-, tri- or higher functional reagents which will typically be low molecular weight materials. In contrast, oligomer fragments which do not include dimer and/or trimer component residues may be used in which case the chain extender(s) will include dimer and/or trimer component residues e.g. using hydroxyl, amine, isocyanate or acid functional dimer or trimer compounds as appropriate. Of course, where the oligomer fragments do include dimer and/or trimer component residues, dimer or trimer based chain extender(s) may also be used.

Generally the proportion of chain extending agent will be chose to be appropriate to provide an oligomer product having a desired molecular weight, higher than that of the oligomer unit(s). The weight percentages will thus depend on the molecular weight of the oligomer units and of the chain extender. When trimer acid is used as the chain extender amounts of from 1 to 40%, more usually from 3 to 30%, particularly 5 to 20% by weight of the oligomer which is being chain extended, will be typical, with similar weight proportions for other trimer based chain extenders and corresponding amounts for chain extenders of different molecular weight and functionality. As with the tri- and higher functional hydroxyl and/or amino functional components mentioned above, mono-functional components may be included to act as chain stoppers to control the overall molecular weight and/or the extent of branching and/or crosslinking. End capping may be carried out after chain extension along the lines described above, though the inclusion of monofunctional components as chain stoppers many make separate end capping unnecessary. We have found that using trimer based chain extenders, particularly with dimer based oligomeric units can give structurants which give structured oils having a reduced tendency to “bleed” (syneresis) and good thermal stability.

The group R¹ in formula (II) and corresponding groups in other formulae, is a C₁ to C₆₀, more usually a C₂ to C₄₄, particularly a C₄ to C₃₆, especially a C₄ to C₂₄, hydrocarbylene group. Synthetically it can be considered as be the residue left after removal of an, and usually two, isocyanate groups from the (di-)isocyanate starting material (see below for oligomer synthesis). Suitable isocyanates include aromatic isocyanates, particularly diisocyanates e.g. phenyl diisocyanate, methylene bis-(4,4′)-phenyl isocyanate (also known as diphenylmethane-4,4′-diisocyanate or MDI), toluene diisocyanate (TDI), tetramethylxylene diisocyanate or derivatives and variants of such materials for example modified MDI; but more usually non-aromatic diisoycanates such as alicyclic isocyanates, particularly diisocyanates e.g. methylene bis-(4,4′)-cyclohexyl isocyanate (4,4′-dicyclohexylmethane diisocyanate), or isophorone diisocyanate; dimer diisocyanate; or, and particularly, alkylene isocyanates, particularly diisocyanates, more particularly C₂ to C₁₂, especially C₂ to C₈, and desirably C₂ to C₆ alkylene, diisocyanates, such as 2,2,4-trimethyl-1,6-hexamethylene diisocyanate; and desirably diisocyanates of the formula: OCN—(CH2)ₚ—NCO where p is from 2 to 12, more particularly from 2 to 8, and especially from 2 to 6 e.g. 1,12-dodecane diisocyanate or 1,6 hexamethylene isocyanate.

The groups R², in formula (II) and corresponding groups in other formulae, when other than H, provide end groups for the oligomer. Where the oligomers are end capped, the end cap groups, designated by —C(O)R³, —(X)—R⁴ in the group —C(O)NH—R¹—NHC(O)—(X)—R⁴, —C(O)NH—R⁴ and —O(AO)ₙ—(CO)ₚR⁴ in formula (II), can be acyl groups, as in R³C(O)—, or hydrocarbyl, as R⁴ in the group —(X)—R⁴, in the group —C(O)NH—R⁴ or in the group —C(O)NH—R⁴, (where —(X)—, R¹, R⁴, R⁵, AO, n and p are as defined in formula (II) above) the groups R³ or R⁴ are independently C₁ to C₆₀, more usually a C₁ to C₄₄, desirably a C₁ to C₂₄, hydrocarbyl, especially alkyl or alkenyl groups.

When the end cap group is a hydrocarbyl group (R⁴) it may be straight or branched chain, open chain or cyclic (including polycyclic), saturated or unsaturated group and is particularly an alkyl or alkenyl group such as stearyl, isostearyl, oleyl, cetyl, behenyl, e.g. as derived from the linear alcohols available under the commercial designations “Nafol” and “Nacol”, the mixtures of linear and branched chain alcohols commercially available as “Lials”; or as derived from Guerbet (branched chain) alcohols e.g. those commercially available under the “Isofol” commercial designations or a cyclic, particularly acyclic, group such as cyclohexyl, or a polycyclic group such as the residue or rosin alcohol for example as derived from Abitol-E from Eastman. Hydrocarbyl end caps can be linked to the oligomeric chain by —O— groups (giving a urethane link) or by —NH— groups (giving a urea link) and a terminal (bis-)isocyanate derived residue.

When R² is an acyl group the group R³ is usually a C₁ to C₅₉ group and more usually is a long chain particularly a C₇ to C₄₃ group, more particularly a C₉ to C₃₁ and especially a C₁₁ to C₂₃ hydrocarbyl group which may be straight or branched chain, open chain or cyclic (including polycyclic), saturated or unsaturated and is desirably an alkyl, alkenyl or alkadienyl group. In other words, R³ is part of an acyl group derived from the corresponding C₂ to C₆₀, particularly C₈ to C₄₄, more particularly a C₁₀ to C₃₂ and especially a C₁₂ to C₂₄, fatty acid. In particular the acyl group —C(O)R³ is derived from a C₈ to C₃₀ fatty acid, particularly lauric, stearic, isostearic, oleic or erucic acids. Other monofunctional acids that can be used include cyclic, particularly acyclic, e.g. polycyclic, acids such as abietic acid (rosin acid). Acyl end caps can be linked to the oligomeric chain by —O— groups (giving an ester link) or by —NH— groups (giving an amide link).

The oligomers used in this invention desirably have a number average molecular weight of from 1000 to 20000, more usually from 1500 to 10000 and particularly from 2000 to 8000. For compounds of the formula (II), this corresponds to (average) values for the index m, including the indices m1 and m2 in formulae (IIa) and (IIb) respectively, of typically from 1 to 20 more usually from 2 to 15 and particularly from 2 to 10 urethane dimer diol oligomer repeat units i.e. the value of the index m, per molecule. Similar numbers of repeat units will be typical for trimer based and other structurant oligomers used in the invention.

Although trifunctional starting materials may be used, when these are present care may be needed to avoid making insoluble or intractable oligomers arising from excessive crosslinking. At least to some extent, the average functionality can be controlled by including non-dimer difunctional reagents in a similar way to those described above with dimer derived OH or NH₂ functional materials and/or monofunctional regents e.g. monofunctional alcohols or amines, may be included as chain stoppers. We have made oligomers that are effective gelling agents using trimer triol as a starting material or by using trifunctional chain extenders such as trimer acid (see below) without having to include monofunctional chain stoppers.

The oligomers used in this invention, particular oligomers including repeat units based on dimer and trimer usints as described above with reference to formulae (I) to (V) above can be made by generally conventional methods. At least notionally, the reactions can be considered as a first stage forming an intermediate oligomer and subsequently, if desired, reacting capping groups onto the intermediate oligomer. The intermediate oligomer can be hydroxyl (diol or triol) or amine (diamine or triamine) ended or isocyanate ended depending in particular on the molar ratio of the starting diol or amine and isocyanate (noting that isocyanate ended oligomers will not usually be left uncapped in view of the reactivity of isocyanate groups).

Thus polyurethanes of the formula (IIa) can be made by reacting a diol of the formula: HO-(D^{a})-OH, where -(D⁸)- is as defined in formula (IIa), with a suitable diisocyanate, particularly of the formula OCN—R¹—NCO, where R¹ is as defined for formula (I), under urethane polymerisation conditions, particularly in the presence of a urethane polymerisation catalyst (see also below), to form the intermediate oligomer. Corresponding reactions can be used to make trimer containing materials.

End caps may be reacted on depending on the groups at the end of the oligomer. Where the oligomer is isocyanate ended, reaction with an alcohol R²OH, where R² is as defined in formula (II), will give a R² substituted urethane ended oligomer and reaction with an amine R²NH₂, where R² is as defined in formula (II), will give a R² substituted urea ended oligomer. Where the oligomer is hydroxyl (diol) ended, the capping reaction may be with an alcohol of the formula: R²OH (or a reactive derivative), where R² is as defined in formula (II), under etherification conditions, particularly in the presence of an etherification catalyst such as potassium carbonate, potassium hydroxide, sodium hydroxide or stannnous octoate, or an acid of the formula R³COOH (or a reactive derivative), where R³ is as defined for formula (II), under esterification conditions, particularly in the presence of an esterification catalyst such as tetrabutyl titanate (TBT), tetra-isopropyl titanate (TIPT), stannous octoate e.g. the commercial product Tegokat 129, bases e.g. potassium or sodium carbonate, acids e.g. para-toluene sulphonic acid (PTSA), dodecyl benzene sulphonic acid (DBSA) or sulphuric acid, more particularly by reacting with an ester of the formula R³COOR⁵, where R³ is as defined for formula (II), and R⁵ is a lower, particularly C₁ to C₈, alkyl and especially a methyl, group under transesterification conditions, particularly in the presence of transesterification catalyst such as TBT, TIPT, stannous octoate, or a base e.g. potassium or sodium carbonate.

Similarly polyureas of the formula (IIb) can be made by reacting a dimer diamine of the formula H₂N-(D^{b})-NH₂, where -(D^{b})- is as defined in formula (IIb), with a suitable diisocyanate, particularly of the formula OCN—R¹—NCO where R¹ is as defined for formula (I), under polyurea polymerisation conditions, particularly in the presence of a polyurea polymerisation catalyst (see also below), to form the intermediate oligomer. Corresponding reactions can be used to make trimer containing materials.

End caps may be reacted on depending on the groups at the end of the oligomer. Where the oligomer is isocyanate ended, reaction with an alcohol R^{2b}OH, where R^{2b} is as defined in formula (IIb), will give a R^{2b} substituted urethane ended oligomer and reaction with an amine R^{2b}NH₂, where R^{2b} is as defined in formula (IIb), will give a R^{2b} substituted urea ended oligomer. Where the oligomer is amine (diamine) ended, the capping reaction may be with an acid of the formula R³COOH (or a reactive derivative), where R³ is as defined for formula (II), under amidation conditions, particularly in the presence of an amidation catalyst such as TBT, TIPT, E-cat (TiO₂ with small amounts of TiCl₄ Ti(OH)₂ and TiCl₂), more particularly by reacting with an ester of the formula R³COOR⁵, where R³ is as defined for formula (II), and R⁵ is a lower, particularly C₁ to C₈, alkyl and especially a methyl, group under transamidation conditions, particularly in the presence of transamidation catalyst such as the amidation catalysts listed above.

From formula (II) the group R² used as an end cap may be the residue of a mono-alkyl or ester capped alkoxylate e.g. propylene glycol monoesters such as the isostearate, and the term “alcohol” for R²OH as used above is generic to include this as well as simple alcohols.

Catalysts for the urethane and urea reactions can be tertiary bases, e.g. bis-(N,N′-dimethylamino)-diethyl ether, dimethylaminocyclohexane, N,N-dimethylbenzyl amine, N-methyl morpholine, reaction products of dialkyl-(b-hydroxyethyl)-amine with monoisocyanates, esterification products of dialkyl-(b-hydroxyethyl)-amine and dicarboxylic acids, and 1,4-diaminobicyclo-(2.2.2)-octane, and non-basic substances such as metal compounds e.g. iron pentacarbonyl, iron acetyl acetonate, tin(II) (2-ethylhexoate), dibutyl tin dilaurate, molybdenum glycolate, stannous octoate, TBT and TIPT.

Generally where the intermediate oligomer is (or would be) hydroxy or amine ended, the reaction will generally be carried out in two stages, first formation of the intermediate oligomer and then capping the oligomer (if desired). Where the intermediate oligomer is (or would be) isocyanate ended, and particularly where the capping groups are hydroxyl compounds (alcohols) the reaction may be carried out in a single step by with all the reagents in a single vessel from the outset.

Where the synthesis includes chain extension reactions, these will usually be urethane or urea forming reactions (between isocyanate and hydroxyl or amine respectively) or ester or amide forming reactions (between carboxylic acid (or reactive derivative) and hydroxyl or amine respectively) and will be carried out under conditions described above for such reactions.

We have generally found it practical to carry out the synthetic reactions without solvent or diluent using the raw materials neat. In particular reagents such as monocarboxylic acid esters included as end capping reagents can act also as reaction diluents/solvents until they are reacted into the oligomers. However, it is possible to use solvents or diluents if desired to improve the ease of handling of the oligomer. Suitable solvents or diluents include acetone, toluene, plasticizer esters, other esters such as benzoates e.g. 2-ethylhexyl benzoate, or isopropyl esters such as ispropyl myristate, glyceride esters such as triglycerides e.g. glycerol trioleate, optionally (partial) esters of polyols, N-methylpyrrolidone, oils and carbonates.

Reactions with isocyanates, oligomerisation or capping reactions, are generally carried out at temperatures from 50 to 150° C., more usually 60 to 125° C. Reactions with acids or esters to form ester or amide end caps with acids are generally carried out at temperatures from 150 to 270° C., more usually 180 to 230° C., e.g. at about 225° C. For both direct and trans-esterification and amidation reactions can be carried out at ambient pressure or at moderate vacuum e.g. from 600 to 10 mBar (60 to 1 kPa) gauge will usually be used. Inert gas e.g. nitrogen, sparging may be used under ambient or reduced pressure to aid removal of valatiles from the reaction. Generally, a small excess of the acid or the ester (usually a methyl ester) will be used.

A wide range of oils (carrier fluids) can be structured using the compounds of the invention and the best such compounds will provide structuring in a wide range of oils (rather than a relatively narrow range for each structuring compound). The range of oil polarity for which structuring can be provided is wide ranging from non-polar oils such as paraffinic oils to alkoxylate oils. One way of expressing this range of polarity is to use a numeric solubility parameter. We have found that Hansen and Beerbower solubility δ^{t} parameter combining dispersive (van der Waals), polar (Coulombic) and hydrogen bonding component (see the CRC Handbook of Solubility Parameters and Other Cohesion Parameters pp 85 to 87) provide good correspondence with the polarity as reflected in the performance of the oils that we have investigated. The numerical values of solubility parameter given below are Hansen and Beerbower δ^{t} values abbreviated as “HBSP” values. Generally structurants of and used in this invention can provide structure in oils with HBSP values ranging from 15 (very non-polar) to 25 (highly polar) particularly from 15 to 22.

Typical oils that can be structured using compounds of the invention include:
liquid and low-melting temperature alcohols including relatively short chain alkanols such as t-butanol and pentanol, medium chain alcohols such as 2-ethylhexanol and 2-ethyl-1,3hexanediol, long chain alcohols such as isodecanol, isotridecanol, cetyl alcohol, oleyl alcohol, octyldodecanol, liquid C₈ to C₃₂ alcohols e.g. Guerbet alcohols such as Isofol 24; liquid polyols such as glycols and (poly)glycerol; aromatic alcohols such as benzyl alcohol; polycyclic alcohols such as abietyl alcohol;
branched liquid fatty alcohols, particularly Guerbet alcohols e.g. octyldodecanol or isostearyl alcohol (see above) e.g. the isostearyl alcohol available from Uniqema (now part of the Croda group) under the tradename Prisorine 3515 (HBSP 17.9);
fatty alcohol polyalkoxylates, particularly propoxylates such as the alkoxylates of C₁₂ to C₂₀ fatty, particularly C₁₄, C₁₆ and C₁₈ fatty alcohols which can be linear e.g. as in palmitic and stearic acids, or branched e.g. as in isostearyl alcohol (in practice a product typically derived from dimer acid manufacture which contains a mixture of mainly branched C₁₄ to C₂₂ alcohols averaging about C₁₈), with from 3 to 25 particularly from 7 to 20 alkoxylate alkoxylate, especially ethoxylate, propoxylate or mixtures of ethoxylate and propoxylate, units e.g. the stearyl alcohol 15-polypropoxylate available from Uniqema under the tradename Arlamol E (HBSP 20.8);
alkoxylated, particularly ethoxylated polyol esters e.g. ethoxylated sorbitan esters such as those sold under the tradename Tween by Uniqema;
ester oils particularly those based on C₂ to C₃₀ linear, branched or unsaturated fatty acids and linear, branched or unsaturated fatty alcohols, and typically esters derived from monocarboxylic acid(s) with monohydric alcohol(s); di- or tri-carboxylic acid(s) with monohydric alcohol(s); or di- or poly-hydric alcohol(s) with monocarboxylic acid(s), e.g. the glycerol tris-2-ethylhexanoate ester oil available from Uniqema under the tradename Estol 3609 (HBSP 20.4), the isopropyl isostearate oil available from Uniqema under the tradename Prisorine 2021 (HBSP 17.7) the methyl oleate oil available from Uniqema under the tradename Priolube 1400 (HBSP 17.9), methyl caprylate, alkyl acetate esters, particularly C₆ to C₁₃ alkyl acetates, and especially where the alkyl groups are oxo-alcohol residues, e.g. the ester oils available under the tradename Exxate from Exxon, synthetic triglyceride esters such as glycerol tri-(C₈ to C₂₄)ates e.g. glycerol tricaprylate such as Estasan 3596, glyceryl trioleate such as Priolube 1435, both available from Uniqema, and glycerol tri ricinoleate, PEG oleate and isostearate, isopropyl laurate or isostearate, trimethylpropane triesters e.g. with mixed C₈/C₁₀, stearic or oleic acids; natural triglycerides such as rape seed (canola) oil, soya oil, sunflower oil and fish oil;
methylated natural triglycerides such as methylated rape seed, soya and/or sunflower oils;
aromatic ester oils, particularly esters if benzoic acid and C₈ to C₁₈ monohydric alcohol(s) e.g. the C₁₂ to C₁₅ benzoate oil from Finetex under the tradename Finsolve TN (HBSP 19.1);
branched liquid fatty alcohols, particularly Guerbet alcohols e.g. octyldodecanol or isostearyl alcohol (see above) e.g. the isostearyl alcohol available from Uniqema under the tradename Prisorine 3515 (HBSP 17.9);
branched liquid fatty acids, particularly isostearic acid and dimer acid (dimerised fatty acids, particularly oleic and/or linoleic acids), such as dilinoteic acid (HBSP 17.8); and
hydrocarbons including toluene, xylene, and liquid paraffinic materials such as hexane, octane, gasoline, diesel, liquid hydrocarbon waxes, lamp oil, paraffinic oils such as Sunspray 6N, 8N and 11N from Sunoco and Puccini 19P from Q8, (iso)-paraffinic oils such as Isopar V and Exxol D140 from ExxonMobil, and aromatic mineral oils such as the alkyl benzenes available from ExxonMobil under the Solvesso brand;
miscellaneous liquids such as isophorone (3,3,5-trimethyl-2-cyclohexene-1-one), liquid (at 25° C.) fatty acids such as caprylic, isostearic, oleic, and vegetable oil fatty acids, ketones such as methyl ethyl ketone (MEK), aldehydes such as butanal;

The liquids (for convenience referred to generically as “oils), particularly as set out above can be used as mixtures of two or more different types of oils.

Of course, as the formulation type is oil based suspensions of active ingredients, it follows that the oil will not be a solvent for the dispersed active, so the choice of oil will complement the desired active(s) in any particular formulation.

The amount of the oligomeric structurant used is typically from 0.2 to 15%, more usually from 0.5 to 10% and especially from 1 to 5%, by weight based on the total formulation. The oligomers may be used as the only structurants or, if desired in combination with other structurants, particularly to ensure that the desired structuring effect it achieved across the entire temperature range required for a particular product. When used with other structurants, the proportion of structurant of the invention will generally be from 25 to 95%, more usually from 40 to 80%, by weight of the total structurant used. The total amount of structurant when mixtures are used will generally be within the ranges given above for the compounds of the invention.

The structurants will generally be incorporated into the oil based formulations by dissolving the structurant in the oil, usually at moderately elevated temperature typically from 50 to 140° C., more usually from 60 to 120° C., commonly from 80 to 110° C., and then cooling the mixture or allowing the mixture to cool to ambient temperature. The structuring effects become apparent on cooling. We have found that the cooling rate can influence the properties of the structured oil based systems. Rapid cooling, particularly “crash” cooling, results in what we believe is a more amorphous structure and a softer structured formulation; slow cooling results in a more ordered, crystalline like structure and a stiffer structured formulation. Generally, thermal cycling below the melting point of the pure oligomer does not appear to influence the behaviour of the material and heating gels to above their melting temperature and re-cooling results in re-gelling of the system.

The oil flowable formulations of the invention can include a wide range of agrochemical active materials and specifically, the active component of the formulation may be one or more plant growth regulators, herbicides, and/or pesticides, for example insecticides, fungicides, acaricides, nematocides, miticides, rodenticides, bactericides, molluscicides and bird repellents. Within this broad range, as is noted above, oil flowable compositions will typically include agrochemical actives which are insoluble in the oil used in the formulation. Given this, active ingredients which can be incorporated into oil based formulations of the invention include:
fungicides: including 2-anilino-4-methyl-6-cyclopropyl-pyrimidine; 2′,6′-dibromo-2-methyl-4′-trifluoro-methoxy-4′-trifluoromethyl-1,3-thiazo-le-5-carboxanilide; 2,6-dichloro-N-(4-trifluoro-methylbenzyl)-benzamide; (E)-2-methoximino-N-methyl-2-(2-phenoxyphenylyacetamide; 8-hydroxyquinoline sulphate; methyl (E)-2-{2-[6-(2-cyanophenoxy)-pyrimidi-n-4-yloxy]-phenyl}-3-methoxyacrylate; methyl (E)-methoximino[alpha-(o-toly-loxy)-o-tolyl]-acetate; 2-phenylphenol (OPP), aldimorph, ampropylfos, anilazine, azaconazole, benalaxyl, benodanil, benomyl, binapacryl, biphenyl, bitertanol, blasticidin-S, bromuconazole, bupirimate, buthiobate, calcium polysulphide, captafol, captan, carbendazim, carboxin, quinomethionate, chloroneb, chloropicrin, chlorothalonil, chlozolinate, cufraneb, cymoxanil, cyproconazole, cyprofuram, carpropamide, dichlorophen, diclobutrazole, dichlofluanid, diclomezin, dicloran, diethofencarb, difenoconazole, dimethirimol, dimethomorph, diniconazole, dinocap, diphenylamine, dipyrithion, ditalimfos, dithianon, dodine, drazoxolon, edifenphos, epoxyconazole, ethirimol, etridiazole, fenarimol, fenbuconazole, fenfuram, fenitropan, fenpiclonil, fentin acetate, fentin hydroxide, ferbam, ferimzone, fluazinam, fludioxonil, fluoromide, fluquinconazole, flusilazole, flusulfamide, flutolanil, flutriafol, folpet, fosetyl-aluminium, fthalide, fuberidazole, furalaxyl, firmecyclox, fenhexamide, guazatine, hexachlorobenzene, hexaconazole, hymexazote, imazalil, imibenconazole, iminoctadine, iprobenfos (IBP), iprodione, isoprothiolan, iprovalicarb, kasugamycin, copper preparations, such as: copper hydroxide, copper naphthenate, copper oxychloride, copper sulphate, copper oxide, oxine-copper and Bordeaux mixture, mancopper, mancozeb, maneb, mepanipyrim, mepronil, metalaxyl, metconazole, metha-sulfocarb, methfuroxam, metiram, metsulfovax, myclobutanil, nickel dimethyldithiocarbamate, nitrothal-isopropyl, nuarimol, ofurace, oxadixyl, oxamocarb, oxycarboxine, pefurazoate, penconazole, pencycuron, phosdiphen, pimaricin, piperalin, polyoxine, probenazole, prochloraz, procymidon, propamocarb, propiconazole, propineb, pyrazophos, pyrifenox, pyrimethanil, pyroquilon, quintozene (PCNB), quinoxyfen, sulphur and sulphur preparations, tebuconazole, tecloftalam, tecnazene, tetraconazole, thiabendazole, thicyofen, thiophanate-methyl, thiram, toldlophos-methyl, tolylfluanid, triadimefon, triadimenol, triazoxide, trichlamide, tricyclazole, tridemorph, triflumizole, triforin, triticonazole, trifloxystrobin, validamycin A, vinclozolin, zineb, ziram and 2-[2-(1-chloro-cyclopropyl)-3-(2-chlorophenyl)-2-hydroxypropyl]-2,4-dihydro-[1,2,4]-triazole-3-thione;
insecticides, acaricides and nematocides such as abamectin, acephate, acrinathrin, alanycarb, aldicarb, alphamethrin, amitraz, avermectin, AZ 60541, azadirachtin, azinphos A, azinphos M, azocyclotin, bacillus thuringiensis, 4-bromo-2-(4-chlorphenyl)-1-(ethoxymethyl)-5-(trifluoromethyl)-1H-pyrrole-3-carbonitrile, bendiocarb, benfuracarb, bensultap, beta-cyfluthrin, bifenthrin, BPMC, brofenprox, bromophos A, bufencarb, buprofezin, buto-carboxine, butylpyridaben, cadusafos, carbaryl, carbofuran, carbophenothion, carbosulfan, cartap, chloethocarb, chloretoxyfos, chlorfen-vinphos, chlorfluazuron, chlormephos, N-[(6-chloro-3-pyridinyl)-methyl]-W-cyano-N-methyl-ethane-imidamide, chlorpyrifos, chlor-pyrifos M, cis-resmethrin, docythrin, dofentezin, cyanophos, cyclo-prothrin, cyfluthrin, cyhalothrin, cyhexatin, cypermethrin, cyromazin, deltamethrin, demeton-M, demeton-S, demeton-S-methyl, diafenthiuron, diazinon, dichlofenthion, dichlorvos, dicliphos, dicrotophos, diethion, diflubenzuron, dimethoate, dimethylvinphos, dioxathion, disutfoton, emamectin, esfen valerate, ethiofencarb, ethion, ethofenprox, ethoprophos, etrimphos, fenamiphos, fenazaquin, fenbutatin oxide, fenitrothion, fenobucarb, fenothiocarb, fenoxycarb, fenpropathrin, fenpyrad, fenpyroximate, fenthion, fenvaterate, fipronil, fluazuron, flucycloxuron, flucythrinate, flufenoxuron, flufenprox, fluvalinate, fonophos, formothion, fosthiazate, fubfenprox, furathiocarb, HCH, heptenophos, hexaflumuron, hexythiazox, imidadoprid, iprobenfos, isazophos, isofenphos, isoprocarb, isoxathion, ivermectin, lambda-cyhalothrin, lufenuron, malathion, mecarbam, mevinphos, mesulfenphos, metaldehyde, methacrifos, methamidophos, methidathion, methiocarb, methomyl, metolcarb, milbemectin, monocrotophos, moxidectin, naled, NC 184, nitenpyram, omethoate, oxamyl, oxydemethon M, oxydeprofos, parathion A, parathion M, permethrin, phenthoate, phorate, phosalon, phosmet, phosphamidon, phoxim, pirimicarb, pirimiphos M, pirimiphos A, profenophos, promecarb, propaphos, propoxur, prothiophos, prothoate, pymetrozine, pyrachlophos, pyridaphenthion, pyresmethrin, pyrethrum, pyridaben, pyrimidifen, pyriproxifen, quinalphos, salithion, sebufos, silafluofen, sutfotep, sulprofos, tebufenozide, tebufenpyrad, tebupirimiphos, teflubenzuron, tefluthrin, temephos, terbam, terbufos, tetrachlorvinphos, thiadoprid, thiafenox, thiamethoxam, thiodicarb, thiofanox, thiomethon, thionazine, thuringiensin, tralomethrin, transfluthrin, triarathen, triazophos, triazuron, trichlorfon, trffiumuron, trimethacarb, vamidothion, XMC, xylylcarb and zetamethrin;
herbicides including—anilides, such as, for example, diflufenican and propanil; arylcarboxylic acids, such as, for example, dichlorpicolinic acid, dicamba and pidoram; aryloxyalkanoic acids, such as, for example, 2,4-D, 2,4-DB, 2,4-DP, fluoroxypyr, MCPA, MCPP and triclopyr; aryloxy-phenoxy-alkanoic acid esters, such as, for example, diclofop-methyl, fenoxaprop-ethyl, fluazifop-butyl, haloxyfop-methyl and quizalofop-ethyl; azinones, such as, for example, chloridazon and norflurazon; carbamates, such as, for example, chlorpropham, desmedipham, phenmedipham and propham; chloroacetanilides, such as, for example, alachlor, acetochlor, butachior, metazachlor, metolachior, pretilachlor and propachlor; dinitroarilines, such as, for example, oryzalin, pendimethalin and trifluralin; diphenyl ethers, such as, for example, actfluorfen, bifenox, fluoroglycofen, fomesafen, halosafen, lactofen and oxyfluorfen; ureas, such as, for example, chlortoluron, diuron, fluometuron, isoproturon, linuron and methabenzthiazuron; hydroxylamines, such as, for example, alloxydim, dethodim, cycloxydim, sethoxydim and tralkoxydim; imidazolinones, such as, for example, imazethapyr, imazamethabenz, imazapyr and imazaquin; nitrites, such as, for example, bromoxynil, dlchlobenil and ioxynil; oxyacetamides, such as, for example, mefenacet; sulphonylureas, such as, for example, amidosulfuron, bensulfuron-methyl, chlorimuron-ethyl, chlorsulfuron, cinosulfuron, metsulfuron-methyl, nicosulfuron, primisulfuron, pyrazosulfuron-ethyl, thifensulfuron-methyl, triasulfuron and tribenuron-methyl; thiocarbamates, such as, for example, butylate, cycloate, diallate, EPTC, esprocarb, molinate, prosulfocarb, thiobencarb and triallate; triazines, such as, for example, atrazine, cyanazine, simazine, simetryne, terbutryne and terbutylazine; triazinones, such as, for example, hexazinon, metamitron and metribuzin; others, such as, for example, aminotriazole, benfuresate, bentazone, cinmethylin, clomazone, clopyralid, difenzoquat, dithiopyr, ethofumesate, fluorochloridone, glufosinate, glyphosate, isoxaben, pyridate, quinchlorac, quinmerac, sulphosate tridiphane, 4-amino-N-(1,1-dimethylethyl)-4,5-dihydro-3-(1-methylethyl)-5-oxo-1H-1,2,4-triazole-1-carboxamide and 2-4((4,5-dihdydro-4-methyl-5-oxo-3-propoxy-1H-1,2,4-triazol-1-yl)carbonyl)amino)sulfonyl)methyl benzoate.

Formulations may be made up as oil dispersions of oil insoluble active(s) with further active(s) dissolved in the oil phase, usually so that on dilution the spray formulation is a suspoemulsion.

The active will generally be included in the OD formulation at a concentration of from 0.5 to 30%, more usually from 1 to 20%, and desirably from 2.5 to 10%, by weight of the formulation.

Surfactants are commonly included in OD formulations in particular to (a) aid dispersion of the active in the oil; and (b) incorporate emulsifier to promote ready emulsification of the oil flowable on dilution with water prior to spraying. For both purposes, it is desirable to use surfactants that are either soluble or dispersible in the oil and thus the choice of surfactant in any particular case will depend on the oil used.

Surfactants which may be included to aid dispersion of the active in the oil include polymeric dispersants such as those available from Uniqema, including polyhydroxyester, particularly poly(hydroxystearic) acid such as Atlox LP-1; ABA polyhydroxyester-PEG-polyhydroxyester copolymers such as Hypermer B-246 and Zephrym PD 2206; polyamine modified polyesters such as Atlox LP-6; and alkyd type copolyesters such as Atlox 4914. With such dispersant surfactants, the amount included in an oil flowable formulation will typically be from 1 to 25, more usually from 2.5 to 15, and desirably from 2.5 to 12.5, weight % of the total formulation.

Surfactants which may be included as emulsifiers to promote ready emulsification of the oil flowable on dilution with water prior to spraying include anionic surfactants particularly sulphonated hydrocarbon surfactants e.g. alkylbenzene sulphonates, particularly as salts such as alkaline earth metal e.g. calcium, salts particularly calcium didodecylbenzene sulphonate; and non-ionic surfactants including block copolymer polyalkoxylates such as those sold under the tradenames Synperonic PE and Atlas G-5000; alkoxylated, particularly ethoxylated fatty alcohols such as those sold under the tradenames Synperonic A and Synperonic 13; sorbitan esters such as those sold under the tradename Span; ethoxylated sorbitan esters such as those sold under the tradename Tween; and ethoxylated sorbitol esters such as POE(40) sorbitol septaoleate such as that sold under the tradename Arlatone T(V) or POE (50) sorbitol hexaoleate such as that sold under the tradename Atlas G-1096 both from Uniqema. With such emulsifier surfactants, the amount included in an oil flowable formulation will typically be from 1 to 25, more usually from 2.5 to 15, and desirably from 2.5 to 12.5, weight % of the oil used in total formulation.

Typically the total surfactant loading including dispersants for the suspended actives and emulsifiers for the oil will be from 5 to 35, more usually from 10 to 20, and desirably from 5 to 15, weight % of the total formulation.

Different types of oils may require different types of surfactant. Thus, for agrochemical formulations based on oils as follows (illustrated with surfactants commercially available from Uniqema):
triglyceride oils—combinations of non-ionic surfactants such as esters of ethoxylated polyols e.g. POE (50) sorbitol hexaoleate (Atlas G-1096) or POE(40) sorbitol septaoleate (Arlatone T(V)), alkyd type copolyesters (Atlox 4914) and anionic surfactants such as alkyl aryl sulphonates usually in salt form such as amine e.g. the isopropylamine alkyl aryl sulphonate Zephrim 330B; commonly in further in combination with polymeric surfactants such as Atlox polymeric surfactants, or block copolymeric alkoxylates such as Atlas 0-5000;
methylated oils—typically use combinations of anionic surfactants such as alkyl aryl sulphonates usually in salt form such as alkali or alkali earth metal salts e.g. the calcium alkyl aryl sulphonate Atlox 4838B (dissolved in ethylhexanol), in combination with a non ionic surfactant such as a fatty alcohol ethoxylates such as C₁₂₋₁₅ 3 to 20 ethoxylates e.g. Synperonic series especially A3, A7, A11, A20, or block copolymeric alkoxylates such as Atlas G-5000;
ester oils such as lower alkyl, particularly methyl esters e.g. methyl oleate,—typically use combinations of non-ionic surfactants, particularly alcohol ethoxylates usually having relatively high HLB values e.g. Synperonic A20, and block copolymeric alkoxylates such as Atlas G-5000 (A-B block) and Synperonic PE105 (A-B-A block), with anionic surfactants such as alkyl aryl sulphonates, particularly linear alkyl benzene sulphonates such as dodecyl benzene sulphonate, especially as calcium salts; mineral oils—combinations of non-ionic surfactants, particularly polyol esters such as sorbitan esters e.g. Span series sorbitan esters particularly Span 80 sorbitan oleate, ethoxylated sorbitan esters e.g. Tween series ethoxylated sorbitan esters particularly Tween 85 POE 20 sorbitan trioleate, and alkyl alkyl sulphonates such as Zephrim 330B;
isoparaffinic oils—esters of ethoxylated polyols e.g. POE (40) sorbitol hexaoleate such as Atlas G-1086 or POE (50) sorbitol hexaoleate such as Atlas G-1096, or block copolymeric alkoxylates such as Atlas G-5000, usually in combination with anionic surfactants such as alkyl aryl sulphonates e.g. Atlox 4838B.
aromatic base oils—typically use combinations of non-ionic surfactants, particularly alcohol ethoxylates usually having relatively high HLB values e.g. Synperonic A20, and block copolymeric alkoxylates such as Atlas G-5000 with anionic surfactants such as alkyl aryl sulphonates, particularly linear alkyl benzene sulphonates such as dodecyl benzene sulphonate, especially as calcium salts.

The surfactants used may influence the performance of the structurant, and some improve it. Thus, for example in formulations based on paraffinic oils such as Puccini 19P from Q8, we have found that inclusion of a surfactant combination such as a sorbitan ester (Span 80 sorbitan oleate), an ethoxylated sorbitan ester (Tween 85 POE 20 sorbitan trioleate) and an aryl alkyl sulphonate (Zephrim 330B) seems to improve the compatibility of the oligomeric structurant with the oil formulation and improves the structuring behaviour as compared with the absence of the surfactants. In general, the ability of the oligomer to provide structuring in oil based formulations seems to be broadly independent of the exact chemical nature of the surfactants used. In other words the formulations of the invention are robust to the presence of and variation of surfactants.

Optionally, an inert solvent and/or plasticiser can be added to the oligomer to improve handling and/or reduce melting temperature of the oligomer. The rheological properties of the structured oil phase can also be modified by addition of solvents and this can be used to modify the rheological properties of the formulation. Examples of solvents which are especially effective in reducing melting range include, 1-phenoxy-2-propanol, 3,7-dimethyl-6-octen-1-ol beta citronellol, 3,7-di-methyl-2,6-octadien-1-ol, 3-hexen-1-ol, cyclohexanone, ethylene glycol monopropyl ether, 2-ethyl-1-hexanol, 1-pentanol, propylene glycol monopropyl ether, 2,4,4-trimethyl-1-pentanol, cyclo-hexanol, hexyl alcohol, ethylene glycol monoisopropyl ether. When used the amount of solvent will generally be used at a proportion of from 10 to 90%, more usually from 40 to 75%, by weight based on the oligomer, representing from 0.5 to 45%, more usually from 1 to 10%, by weight based on the overall formulation.

The formulations may include other components such as dispersants, electrolytes, welters and similar materials that are commonly included in OD formulations.

Overall the formulations of the invention generally have compositions falling within the following ranges:

| | Amount (% by weight) | | |
|---|---|---|---|
| Material | Broad | Specific | Preferred |
| Oil | 10 to 95 | 20 to 90 | 40 to 80 |
| Active | 0.5 to 30 | 1 to 20 | 2.5 to 10 |
| Structurant | 0.1 to 15 | 0.2 to 10 | 0.5 to 5 |
| Total Surfactant (when present) | 5 to 35 | 10 to 20 | 5 to 15 |
| Dispersant | 1 to 25 | 2.5 to 15 | 2.5 to 12.5 |
| Emulsifier | 1 to 25 | 2.5 to 15 | 2.5 to 12.5 |
| Solvent (when present) | 0.1 to 45 | 0.2 to 30 | 0.5 to 15 |
| Total | 100 | 100 | 100 |

The oil based agrochemical formulations of the invention are structured typically to provide dispersion stability desirably without making the oil based formulation so viscous that mixing of the oil based formulation particularly with water to form a spray mix becomes difficult. Mixing difficulties can arise in two ways, if the oil based formulation is sufficiently viscous that removing it from its storage container becomes difficult or if its viscosity make mixing with the dilution water slow or inefficient. This means that the desirable rheology for the structured oil based agrochemical formulations of the invention is a gel which is readily shear thinning so that it readily becomes pourable and/or pumpable, but which is structured so as to provide improved dispersion of the agrochemical active. Generally the structured formulations of the invention have a viscosity at low shear e.g. ca 10 s⁻¹, of from 250 to 3000 mPa·s and thin down at higher shear so that the viscosity of the formulation during mixing with dilution water is typically from 100 to 500 mPa·s (substantially higher viscosities might inhibit efficient mixing with the dilution water).

It is desirable that the structured oil based formulations should remain stably structured at ambient temperature for at least 1 month and at elevated temperatures typically up to at least 40° C. and desirably up to 50° C., for at least 2 weeks and at subambient temperatures usually at least as low as 0° C. and more usually down to −10° C. and desirably as low as −17.7° C. (0° F.) for up to eight weeks. These performance requirements are desirably also met when the formulations include surfactants, and solvents (when present) as well as suspended solids. It is also desirable to have freeze thaw stability over at least 3 test cycles.

The structured concentrates of the present invention are generally gels in which the dispersion of the agrochemical active is stabilised by the structured and desirably gel, nature of the concentrate. It is advantageous that the oligomer structurants can provide structuring over a wide range of oil polarity, thus enabling the selection of a suitable (non-solvent) oil for widely differing actives that it is desired to formulate as ODs, and to give structured dispersions that are stable over a range of thermal conditions appropriate to storage and use of the agrochemical formulations. the structuring is linked with good shear thinning properties that simplify dilution and thus making up spray formulations for practical application. It is particularly advantageous that the structuring is stable in the presence of useful concentrations of surfactants typically used in OD formulations. Further as manufacture of the oligomers does not necessarily use solvent, solvent, especially volatile solvent, free formulations can be made.

The oil based formulations of the invention including structurant, usually surfactant and suspended solid active can be readily emulsified by simple mixing with diluent water to give stable emulsions with the base oil as the dispersed phase in the dilution water. The resulting aqueous formulation, usually an emulsion of the oil with the active suspended in the oil discontinuous phase is sprayed on vegetation, usually a crop and or weeds, or the ground adjacent to the crops to provide the desired agrochemical effect. Of course if a further active is included dissolved in the oil, the diluted formulation will naturally be a suspoemulsion formulation. Typically the rate of dilution with water for such OD, formulations will be from 10 to 10000, more usually 10 to 1000 e.g. 20 to 100, fold by volume. The dilution water does not need to be soft, we have used water having a standard hardness up to 1000 ppm Ca²⁺ to dilute structured oil formulations successfully.

The invention thus includes a method of making a diluted agrochemical formulation for spraying (spray tank mix) which includes mixing in any order:
a) an oil based formulations of the invention, desirably including at least one emulsifier surfactant; and
b) water, particularly in an amount of from 20 to 100 times by volume of component a; to form a diluted agrochemical formulation.

We have observed that the structured oil based systems of and used in this invention are moderately sticky and in diluted spray formulations this may enhance the adhesion of agrochemical components onto the substrate to be treated e.g. a plant or a pest such as an insect.

Typically oil flowable formulations will be applied at a rate of from 100 to 400 l(spray).ha⁻¹(crop treated), usually about 300 l.ha⁻¹ corresponding to application rates of the oil based concentrate (oil flowable) of from 1 to 20, more usually from 2 to 10 and desirably from 2 to 7 l(oil flowable concentrate).ha⁻¹(crop treated). The amount of active applied will depend on the potency of the active and the desired effect.

The agrochemical spray formulations made by diluting the oil based formulations of the invention will normally be used to apply agrochemicals to vegetation or the ground adjacent to vegetation and accordingly the invention includes a method of treating vegetation in which the vegetation or the ground adjacent to vegetation is sprayed by a formulation of the invention, particularly a diluted formulation of the invention.

The following examples illustrate the invention. All parts and percentages are by weight unless otherwise stated.

### Materials

Fatty acid oligomer based starting materials
DD1 dimerdiol (2% monomer, 96.5% dimer 1.5% trimer) Pripol 2033 ex Uniqema
DD2 trimer triol (containing 2% monomer, 54.5% dimer 43.5% trimer)
DD3 hydroxyl ended oligomer from reaction of dimer acid and ethylene glycol
DD4 dimer diamine
DD5 dimer diol/dimer acid oligomer, Priplast 3197 ex Uniqema
DD6 trimer acid ex Uniqema
DD7 hydroxyl ended ethylene glycol dimer acid oligomer
Non-(fatty acid oligomer) diols
D1 1,6-hexanediol (MP 39-42° C.)
D2 1,4-butanediol
D3 2-ethyl-hexane-1,3-diol
D4 isosorbide
D5 bisphenol A 2.2 propoxylate
D6 ethylene glycol
Non-(fatty acid oligomer) amines
A1 monoethanolamine
A2 ethylene diamine

### Isocyanates

IC1 Hexamethylene diisocyanate (HDI), Desmodur H ex Bayer

### IC2 HDI-trimer, Desmodur N3600 ex Bayer

IC3 dicyclohexanemethane-4,4′-diisocyanate, Desmodur W ex Bayer
IC4 modified MDI, Desmodur CD ex Bayer
IC5 3-isocyanatopropyl-trimethoxysilane, Silquest ex GE Silicones
Urethane/urea reaction catalysts
UC1 di-butyl stannous di-laurate
UC2, stannous octoate
Esterification/transesterification catalysts
TBT tetrabutoxytitanate [Ti(O-n-C₄H₉)₄] as 20 wt % solution in dioctyl azelate
SO stannous octoate Tegocat 129 ex Goldschmidt
Other reagents
Est1 methyl isostearate Prisorine 3760 ex Uniqema
Est2 methyl stearate
Est3 methyl oleate, Priolube 1400 ex Uniqema
Est4 methyl benzoate
Alc1 stearyl alcohol
Alc2 isostearyl alcohol
Alc3 Branched C₃₂ alcohol, Isofol 32 ex Sasol
Alc4 Branched C₂₀ alcohol, Isofol 20 ex Sasol
Alc5 Propylene glycol monoisostearate Prisorine 2034 ex Uniqema

### Oils

Oil1 methyl oleate—Prolube 1400 ex Uniqema
Oil2 glycerol trioleate—Prolube 1435 ex Uniqema
Oil3 paraffinic mineral oil—Puccini P19 ex Q8
Oil4 alkyl benzene oil—Solvesso 150 ex ExxonMobil
Oil5 isoparaffin mineral oil—Isopar M ex ExxonMobil
Oil6 aliphatic cycloparafinic hydrocarbon—Exxsol D140 ex ExxonMobil
Agrochemical active materials
Act1 chlorothalonil—benzenedicarbonitrile fungicide ex Syngenta.
Act2 atrazine—triazine herbicide ex Syngenta.
Act3 iprodione—dicarboximide fungicide ex Bayer.
Act4 acetochior (oil soluble active)

### Surfactants

Surf1 calcium alkylaryl sulphonate in 2-ethylhexanol (60% active), Atlox 4838B ex Uniqema
Surf2 block polyalkylene glycol ether, Atlas G5000 ex Uniqema
Surf3 polymeric surfactant, Atlox 4914 ex Uniqema
Surf4 ethoxylated primary alcohol, Synperonic A20 ex Uniqema
Surf5 POE (15) monobranched fatty alcohol, Atlox MBA 13/10 ex Uniqema
Surf6 POE (40) sorbitol septaoleate ex Uniqema
Surf7 polyoxyethylene (20) sorbitan trioleate, Tween 85 ex Uniqema
Surf8 polymeric surfactant, Hypermer 8206 ex Uniqema
Surf9 alkylaryl sulphonate, Zephrim 330B ex Uniqema
Surf10 sorbitan monooleate, Span 80

### Test Methods

The general rheological properties of gels made using oligomers made in the Synthesis Examples were investigated using a USD200-Physica PAAR rheometer. Yield Stress, Viscosity, Critical Strain and Thixotropy Index were measured under isothermal steady state conditions at 25±0.1° C., using a cone-plate attachment (50 mm diameter, 2°); melting point was measured using a plate-plate attachment (50 mm gap 1 mm).
Yield Stress (YS)—was measured by the method of DIN 143 and the results are in Pa.
Viscosity (V)—was measured by the method of ISO 321 9 with measured viscosity points obtained for the entire viscosity curve with the results in mPa·s at shear rates of 10 s⁻¹ and 100 s⁻¹.
Critical Strain (CS)—was measured by the method of ISO 321 9 and results are given as % strain.
Melting Point (MP)—of the structured formulation was measured by the method of DIN 53018 part 1 using temperature sweep dynamic test and the results are given in ° C.
Thixotropy Index (TI)—was measured using a three condition rotational test: initial rest phase-load phase—recovery phase (after removing load); Thixotropy Index is the numerical ratio of the viscosity after 15 minutes in the recovery phase to the initial viscosity.
Viscosity V—was also measured using a Brookfield viscometer No 3 RVLT Spindle, with the results in mPa·s at the stated spindle speeds.
Freeze thaw stability—is tested on structured oils and formulations based on them by treating a test sample to one or more, typically 3, cycles of heating and cooling between ambient temperature/50° C./−17.7° C. (0° F.)/returning to ambient using a rate of change of temperature of ca 0.1° C. min⁻¹ (+ or − as appropriate) without holding time at the maximum and minimum temperatures, so that a complete cycle takes one day.

### EXAMPLE SE1

### Preparation of an Ester-Terminated Polyurethane Structurant

Dimer diol (DD1) (581 g; 1.07 mol) and methyl isostearate (Est1) (216.3 g; 0.71 mol) were charged to a 2 l flanged flask (“reactor”) equipped with an external electrical heater, nitrogen inlet, thermometer, condenser and receiving vessel, central stirrer and addition port. The mixture was heated under an inert nitrogen atmosphere (maintained throughout the reaction) to ca. 60° C. and hexanediol (D1) (30.3 g; 0.26 mol) was added and allowed to dissolve. Catalyst UC1 (400 μl) was then added and hexamethylene diisocyanate (IC1) (172.4 g; 1.02 mol) added through the addition port using a dosing pump at a rate of 150 g.h⁻¹.kg⁻¹. During this addition the temperature rose because of the exothermic reaction between the diols and diisocyanate. On completion of the diisocyanate addition, the mixture was rapidly heated to 225° C., TBT (440 μl) was added and the mixture held at 225° C. until the hydroxyl value fell to 10 mg(KOH).g⁻¹ (or less). The reaction mixture was allowed to cool to 140-150° C. under nitrogen sparge and the product discharged and allowed to cool to ambient temperature to yield the oligomer as a slightly yellow hazy waxy solid.

### EXAMPLE SE2

### Preparation of a Polyurethane Structurant

Dimer diol DD1 (631.6 g; 1.16 mol) and isostearyl alcohol (A1c2) (108.5 g; 0.4 mol) were charged to a reactor as described in Example 1 and heated to 60° C. Catalyst UC1 (400 μl) was then added followed by diisocyanate IC1 (259.9 g; 1.55 mol) added through the addition port as described in Example 1. On completion of the diisocyanate addition, the mixture was rapidly heated to 125° C. and held at 125° C. for 3 hours after which the hydroxyl value was <5 mg(KOH).g⁻¹. The product was discharged and allowed to cool to ambient temperature to yield the oligomer as a white rubbery translucent solid.

### EXAMPLE SE3

### Preparation of a Polyurethane Structurant Incorporating a Higher Functional Polyol

Trimer triol (DD2) (613.6 g; 0.94 mol), methyl stearate (Est2) (189.1 g; 0.65 mol) and stearyl alcohol (A1c1) (44.9 g; 0.17 mol) were charged to a reactor as described in Example 1. The mixture was heated under an inert nitrogen atmosphere (maintained throughout the reaction) to ca. 60° C., catalyst UC1 (400 μl) added and diisocyanate IC1 (152.4 g; 1.02 mol) added through the addition port as described in Example 1, followed by rapid heating to 180° C. Catalyst UC2 (stannous octoate) (0.8 g) was then added, the pressure reduced to 10 mbar and the mixture held at 180° C. until the hydroxyl value fell to 10 mg(KOH).g⁻¹ (or less). The reaction mixture was allowed to cool to 140-150° C., the vacuum released and the product discharged and allowed to cool to ambient temperature to yield the product oligomer as a white, opaque solid.

### EXAMPLE SE4

### Preparation of an Ester-Terminated Polyurethane Structurant Incorporating a Higher Functional Isocyanate

Dimer diol DD1 (607.3 g; 1.11 mol) and methyl isostearate (Est1) (261.4 g; 0.85 mol) were charged to a reactor as described in Example 1 and the mixture was heated under an inert nitrogen atmosphere (maintained throughout the reaction) to ca. 60° C. and catalyst UC1 (400 μl) was then added. Higher functional isocyanate IC2 (17.66 g; 0.03 mol) and diisocyanate IC1 (172.4 g; 1.02 mol) were added through the addition port as described in Example 1 followed by rapid heating to 225° C. Catalyst TBT (4.40 μl) was then added and the mixture held at 225° C. until the hydroxyl value fell to 10 mg(KOH).g⁻¹ (or less). The reaction mixture was allowed to cool to 140-150° C. under nitrogen sparge and the product discharged and allowed to cool to ambient temperature. The product oligomer obtained was a light yellow, translucent solid.

### EXAMPLE SE5

### Preparation of an Ester-Terminated Oligomeric Structurant with Mixed Polyurethane and Polyurea Backbone

Dimer diol DD1 (530.1 g; 0.97 mol) methyl isostearate (Est1) (244.7 g; 0.8 mol) and monoethanol-amine (A1) (28.6 g; 0.47 mol) were charged to a reactor as described in Example 1 and heated to 60° C. Catalyst UC1 (400 μl) was then added, diisocyanate IC1 (196.6 g; 1.17 mol) added as described in Example 1, the mixture was rapidly heated to 225° C., TBT (440 μl) was added and the mixture held at 225° C. until the hydroxyl value fell to 10 mg(KOH).g⁻¹ (or less). The reaction mixture was allowed to cool to 140-150° C. under nitrogen sparge and the product discharged and allowed to cool to ambient temperature as a light yellow, opaque solid.

### EXAMPLE SE6

### Preparation of an Amide-Terminated Polyurea Structurant

Dimer diamine DD4 (627 g; 1.15 mol) and methyl isostearate (Est1) (242.8 g; 0.79 mol) were charged to a reactor as described in Example 1 and heated to 60° C. Catalyst UC1 (400 μl) was then added, diisocyanate IC1 (130.1 g; 0.77 mol) added as described in Example 1, the mixture was rapidly heated to 225° C., TBT (440 μl) was added and the mixture held at 225° C. until the hydroxyl value fell to 10 mg(KOH).g⁻¹ (or less). The reaction mixture was allowed to cool to 170 to 180° C. under nitrogen sparge and the product discharged and allowed to cool to ambient temperature as a light brown, opaque solid.

### EXAMPLE SE7

### Preparation of a Polyurethane Structurant

Dimer diol (DD1) (440.38 g; 0.81 mol), isostearyl alcohol (A1c2) (239.99 g; 0.89 mol) and 1,6-hexanediol (D1) (47.81 g; 0.4 mol) were charged to a reactor as described in Example 1 and heated to 70° C. Catalyst UC1 (500 μl) was then added followed by diisocyanate IC1 (271.82 g; 1.82 mol) added through the addition port as described in Example 1. During addition of diisocyanate the reaction temperature is increased at a rate of 40° C./h until the temperature reaches 140° C. The reaction mixture is kept at this temperature throughout the dosing in completed, followed by an additional 2.5 hours. The hydroxyl value was <10 mg(KOH).g⁻¹. The product was discharged and allowed to cool to ambient temperature to yield the oligomer as a white rubbery translucent solid.

The cooled oligomer products may be ground e.g. in a cryogenic centrifugal mill, to produce a powder form for ease of handling and subsequent incorporation into formulations.

Further oligomeric structurants were made generally as described above using the materials and molar proportions (ratios) set out in Table SE1 below.

TABLE SE1

| | Reagents | | | | | | | |
|---|---|---|---|---|---|---|---|---|
| SE | dimer/trimer | | diol(s)/amine(s) | | isocyanate(s) | | end group | |
| No | type | amt | type | amt | type | amt | type | amt |
| SE 1 | DD1 | 1 | D1 | 0.25 | IC1 | 1 | Est1 | 0.5 |
| SE 2 | DD1 | 1 | — | — | IC1 | 1.33 | Alc2 | 0.67 |
| SE 3 | DD2 | 1 | — | — | IC1 | 1.2 | Alc1 | 1.9 |
| | | | | | | | Est2 | 0.55 |
| SE 4 | DD1 | 3.3 | — | — | IC1 | 2.1 | Est1 | 2.1 |
| | | | | | IC2 | 0.1 | | |
| SE 5 | DD1 | 1 | A1 | 0.5 | IC1 | 1.25 | Est1 | 0.5 |
| SE6 | DD4 | 1 | — | — | IC1 | 0.75 | Est1 | 0.5 |
| SE7 | DD1 | 0.81 | D1 | 0.4 | IC1 | 1.62 | Alc1 | 0.89 |
| SE8.1 | DD1 | 1 | — | — | IC1 | 0.75 | Est3 | 0.5 |
| SE8.2 | | | — | — | | | Est1 | 0.5 |
| SE8.3 | | | — | — | | | Est2 | 0.5 |
| SE8.4 | | | — | — | | | Est4 | 0.5 |
| SE9 | DD1 | 1 | — | — | IC1 | 1 | Est1 | 0.67 |
| | DD7 | 0.33 | | | | | | |
| SE10 | DD1 | 1 | D4 | 0.33 | IC3 | 1 | Est1 | 0.67 |
| SE11 | DD1 | 1 | D2 | 0.25 | IC1 | 1 | Est1 | 0.5 |
| SE12 | DD1 | 1 | — | — | IC1 | 0.4 | Est1 | 0.33 |
| | | | | | IC4 | 0.33 | | |
| SE13 | DD1 | 1 | D1 | 0.375 | IC1 | 1.125 | Est1 | 0.5 |
| SE14 | DD1 | 1 | D1 | 0.42 | IC1 | 1.125 | Est1 | 0.66 |
| | | | D3 | 0.33 | | | | |
| SE15 | DD4 | 1 | A2 | 0.14 | IC1 | 1.43 | Est1 | 0.57 |
| SE16 | DD1 | 1 | — | — | IC1 | 1.33 | Alc1 | 0.67 |
| SE17 | DD1 | 1 | — | — | IC1 | 0.75 | Alc3 | 0.5 |
| SE18 | DD1 | 1 | D1 | 0.33 | IC1 | 1 | Alc2 | 0.67 |
| SE19 | DD1 | 1 | — | — | IC1 | 1.33 | Alc4 | 0.67 |
| SE20 | DD1 | 1 | D3 | 0.33 | IC1 | 1.67 | Alc2 | 0.67 |
| SE21 | DD1 | 1 | D1 | 1 | IC1 | 4 | Alc2 | 1 |
| | DD5 | 1 | | | | | | |
| SE22 | DD1 | 1 | D1 | 0.14 | IC1 | 1.43 | Alc5 | 0.57 |
| SE23 | DD1 | 1 | D5 | 0.2 | IC1 | 1.6 | Alc5 | 1 |
| SE24 | DD1 | 1 | — | — | IC1 | 0.75 | IC5 | 0.5 |
| SE25 | DD1 | 1 | D2 | 0.5 | IC1 | 1.25 | Est1 | 0.5 |
| SE26 | DD1 | 1 | D1 | 0.5 | IC1 | 1.25 | Est1 | 0.5 |
| SE27 | DD1 | 1 | D1 | 0.33 | IC1 | 1 | Est1 | 0.67 |
| SE28 | DD1 | 1 | — | — | IC1 | 0.67 | Est1 | 0.67 |
| SE29 | DD1 | 1 | D2 | 0.2 | IC1 | 1 | Est1 | 0.75 |
| | | | D6 | 0.13 | | | | |
| SE30 | DD1 | 1 | — | — | IC1 | 0.72 | Est1 | 0.32 |
| | DD6 | 0.1 | | | | | | |

Various of the oligomers were assessed for their structurant properties in a number of oils using test methods as described above and the results are set out in Table SE2 below

TABLE SE2

| Polymer | | Conc. | YS | Viscosity (mPa · s) | | CS | MP | |
|---|---|---|---|---|---|---|---|---|
| SE No | Oil | (% w/w) | (Pa) | 10 s⁻¹ | 100 s⁻¹ | (%) | (° C.) | TI |
| SE8.2 | Oil1 | 4 | 20-30 | 800-1000 | 400-500 | 1-2 | 30-35 | 0.25 |
| SE25 | Oil1 | 2 | 40-50 | 700-1000 | 400-500 | 0.3-1 | 40-45 | 0.75 |
| SE26 | Oil1 | 2 | 35-50 | 900-1100 | 400-500 | 1-1.5 | 40-45 | 0.70 |
| SE13 | Oil1 | 1 | 15-25 | 600-800 | 400-500 | 0.2-0.6 | 45-55 | 0.52 |
| SE13 | Oil1 | 1.5 | 30-40 | 700-900 | 500-600 | 0.5-1 | 50-60 | 0.64 |
| SE13 | Oil1 | 2 | 35-50 | 800-1200 | 500-600 | 1.5-2 | 60-70 | 0.81 |
| SE25 | Oil2 | 1.5 | 15-30 | 1000-1200 | 700-800 | 1-1.5 | 40-45 | 0.61 |
| SE25 | Oil2 | 2 | 25-40 | 1500-2000 | 800-1000 | 1.5-1.8 | 40-45 | 0.69 |
| SE25 | Oil2 | 2.5 | 40-60 | 2100-2500 | 900-1100 | 2-2.5 | 40-45 | 0.78 |
| SE 1 | Oil2 | 2 | 20-30 | 1500-2000 | 800-1000 | 1.5-2 | 45-50 | 0.70 |
| SE13 | Oil2 | 1 | 20-30 | 1000-1200 | 800-1000 | 0.5-0.9 | 55-65 | 0.68 |
| SE27 | Oil3 | 2 | 20-35 | 1300-1600 | 1000-1100 | 1-1.3 | 30-40 | 0.36 |
| SE13 | Oil3 | 2 | 15-25 | 1200-1500 | 900-1100 | 1-1.5 | 25-35 | 0.49 |
| SE18 | Oil4 | 1 | 20-40 | 800-1000 | 500-600 | 0.6-1 | 40-45 | 0.68 |
| SE18 | Oil4 | 1.5 | 30-50 | 900-1100 | 500-600 | 1-1.3 | 45-50 | 0.76 |
| SE18 | Oil4 | 2 | 60-70 | 1200-1500 | 600-700 | 1-2 | 50-60 | 0.84 |
| SE19 | Oil4 | 2 | 50-80 | 1200-1600 | 600-700 | 1-1.5 | 45-55 | 0.61 |
| SE28 | Oil5 | 3 | 50-60 | 1500-1900 | 1000-1100 | 1.5-2 | 40-45 | 0.51 |

In further testing of the oligomers, Model Example ME1 to ME5 and in Application Examples AE1 to AE5, for convenience under experimental conditions to reduce the temperature at which the structurant is added to the other formulation ingredients, solutions of the structurant oligomers in low molecular weight solvents were made up and used. The solutions were made up by dissolving finely ground solid oligomer in the chosen solvent at moderately elevated temperature and the solution stored warm to keep it as a liquid. The solvents used with the various oligomers and the temperatures (in ° C.) used to dissolve the oligomers (“soln temp”) and store the solutions (“store temp”) are summarised below:

| | | | | | soln | store |
|---|---|---|---|---|---|---|
| Ex No | Solvent | % | Oligomer | % | temp | temp |
| ME1 | cyclohexanol | 75 | SE18 | 25 | 95 | 75 |
| ME2 | 1-pentanol | 60 | SE21 | 40 | 85 | 70 |
| ME3 | cyclohexanol | 60 | SE26 | 40 | 85 | 68 |
| ME4 | cyclohexanol | 75 | SE27 | 25 | 80 | 72 |
| ME5 | cyclohexanol | 60 | SE8.2 + | 10 + 30 | 85 | 69 |
| | | | SE29 | | | |
| AE1.1 | 2-ethylhexanol | 75 | SE13 | 25 | 70 | 60 |
| AE1.2 | 2-ethylhexanol | 75 | SE13 | 25 | 70 | 60 |
| AE1.3 | 2-ethylhexanol | 75 | SE13 | 25 | 70 | 60 |
| AE2 | 2-ethylhexanol | 75 | SE13 | 25 | 70 | 60 |

* for ME5 the solution was made up using 10 wt % oligomer SE8.2, 30 wt % oligomer SE29 and 60 wt % cycolhexanol.

In the following Examples, the phrase “oligomer solution” refers to these solutions identified by the Example No as given above.

### Model Examples ME1 and ME2

These Examples illustrate structuring of oils using oligomeric structurants. The following formulations were used:

| | oligomer solution* | | | Oil | |
|---|---|---|---|---|---|
| Ex No | type | wt % | ° C. | type | wt % |
| ME1 | SE18/cyclohexanol | 10 | 75 | Oil4 | 90 |
| ME2 | SE21/1-pentanol | 9 | 70 | Oil6 | 91 |

*as described above - amounts are wt % of the solutions, temperatures are store temperatures. In each case, the Oil was added to a Waring Blender and the preheated oligomer solution of was mixed with the Oil in the Blender at ambient temperature at low speed (750 rpm; 12.5 Hz) for ca 1 minute until uniformly dispersed.

The formulations were allowed to stand (and set) at ambient temperature overnight. In both cases the result was a gel which remained stable up to 50° C. The gel from ME2 was subjected to freeze thaw testing and after 3 cycles, the oil retained its gel structure without any loss or degradation of properties.

The formulations in Model Examples ME3 to ME5, are similar to agrochemical formulations, but substitute pigment grade titanium dioxide for agrochemical to simplify handling. Using TiO₂ in this way is a strict test of the ability of the oligomers to provide suitable structuring, because TiO₂ is significantly more dense than most agrochemical active materials used in OD formulations.

### Model Examples ME3 to ME5

Oil suspension concentrates were made up based on a various oils and using titanium dioxide as the dispersed phase. The following materials were used:

| | amount (wt %) | | |
|---|---|---|---|
| Material | ME3 | ME4 | ME5 |
| oligomer solutions: | | | |
| 40% SE26 in cyclohexanol (68° C.) | 2.5 | — | — |
| 25% SE27 in cyclohexanol (72° C.) | — | 12 | — |
| 40% 1:3 mix of SE8.2 and SE29 in | — | — | 7.5 |
| cyclohexanol (69° C.) | | | |
| Oil | | | |
| Oil2 (triglyceride) | 60 | — | — |
| Oil5 (isoparaffln) | — | 56 | — |
| Oil3 (paraffinic) | — | — | 55.5 |
| Surfactants | | | |
| Surf1 | 6.3 | — | — |
| Surf2 | 2.5 | — | — |
| Surf5 | 1.2 | — | — |
| Surf6 | 12.5 | — | — |
| Surf7 | — | 13 | 13.5 |
| Surf8 | — | 5 | — |
| Surf9 | — | 4 | 0.7 |
| Surf10 | — | — | 2.8 |
| titanium dioxide | 15 | 10 | 20 |

In each case, the Oil and surfactants were added to a Waring Blender and the preheated oligomer solution was mixed into the oil/surfactant mixture in the Blender at ambient temperature at low speed (750 rpm) for ca 1 minute until uniformly dispersed. Further mixing was done with either high or low shear mixing.

2nd step using high shear mixing—the TiO₂ was added to the Oil based mixture and the resulting slurry was mixed at high speed (8000 rpm: ca 133 Hz) at ambient temperature, in a high shear Silverson SL2T mixer for 20 minutes.

2nd step using low shear mixing—the TiO₂ was added to the Oil based mixture and the slurry was mixed at low speed (750 rpm) at ambient temperature in a Silverson SL2T mixer for 20 minutes.

The mixtures obtained were allowed to stand (and set) at ambient temperature overnight. For each Model Example, both the high and low shear mixtures set into gels although the high shear gel mix had a lower viscosity than the low shear gel mix. These results indicate a difference in viscosity depending on the shear applied during mixing. All mixtures showed strongly shear-thinning behaviour. No sedimentation of the titanium dioxide particles was observed with any of the gel mixes.

The thermal stability of the gel mixes was tested by storing samples at ambient temperature for a month and in an oven at ca 50° C. for two weeks; at the end of the test period, no sedimentation was observed with any of the gel mixes.

Samples of the gel mixes of ME4 were tested for freeze thaw stability through 3 test cycles and no sedimentation was observed in either sample.

Samples of the gel mixes were stirred at low shear (250 rpm; ca 4.2 Hz) and separately added to test aliquots of cold water of standard hardness (Ca²⁺) of 50, 342 and 1000 ppm, to give a concentration of 5 v/v % in the water. After 10 gentle rotations of the mix in a test tube, a good emulsion was obtained in all cases.

The following Application Examples show the dispersion and suspension of agrochemical actives in oil phases structured using oligomers as described above.

### APPLICATIONS EXAMPLE 1

Oil based Suspension Concentrate formulations were made up using the materials set out in Table AE1a below

TABLE AE1a

| Ex | Active | | Structurant* | | Surfactants | | | | Oil | |
|---|---|---|---|---|---|---|---|---|---|---|
| No | Type | % | Type | % | Surf1 | Surf2 | Surf3 | Surf4 | Type | % |
| AE1.1 | Act1 | 30 | SE13 | 4 | 3.2 | 0.87 | 2.1 | 1.2 | Est2 | 56.6 |
| AE1.2 | Act2 | 20 | SE13 | 5 | 3.2 | 0.87 | 2.1 | 1.2 | Est2 | 67.63 |
| AE1.3 | Act3 | 17.14 | SE13 | 5.17 | 3.31 | 0.9 | 2.17 | 1.24 | Est2 | 70.04 |

*as 25% w/w solution in 2-ethylhexanol

The active OD formulations were made up by adding the structuring oligomer into the oil/solvent system before or after addition of the active ingredients. To illustrate the property variation so obtained, chlorthalonil and atrazine formulations were prepared by both procedures; iprodione was prepared only by the ‘pre-structured’ method (A samples).

‘Pre-structured’ formulations (A samples)

The oil, surfactants and oligomer solution were mixed at low speed at ambient temperature in a Waring Blender for about 1 minute until uniformly dispersed. The active was then added, and the blended slurry transferred to a jacketed (10° C.) Attritor (high shear mixer/mill for dispersing solids in liquids, made by Union Process), rotating at 490 rpm (ca 8.2 Hz), containing 3-mm diameter milling balls, and milled for 20 minutes.

‘Post-structured’ formulations (B samples)

The oil and surfactants were mixed at low speed at ambient temperature in a Waring Blender for about 1 minute until uniformly dispersed. The active was then added, and the blended slurry transferred to a jacketed (10° C.) Attritor, as described above, and milled for 15 minutes. The oligomer solution was then added, and the slurry milled for a further 5 minutes. Formulations were allowed to set at room temperature overnight and the Brookfield viscosity (No 3 RVLT Spindle) at various spindle speeds is reported in Table AE1b below.

TABLE AE1b

| | | | Brookfield Viscosity (@ spindle speed in rpm) (mPa · s) | | | | | |
|---|---|---|---|---|---|---|---|---|
| Ex No | Type | Active | 0.5 | 1 | 2.5 | 5 | 50 | 100 |
| AE1.1 | A | Act1 | 12200 | 7900 | 3600 | 2120 | 352 | 231 |
| | B | | 39000 | 22500 | 10040 | 5780 | 882 | 516 |
| AE1.2 | A | Act2 | 15000 | 8700 | 3840 | 2000 | 315 | 194 |
| | B | | 115000 | 45100 | 21400 | 12300 | 1340 | 790 |
| AE1.3 | A | Act3 | 52000 | 30400 | 14360 | 8150 | 998 | 709 |

These data indicate a difference in viscosity behaviour depending on the order of addition in making the formulation. However, all products are strongly shear-thinning and are able to suspend the actives in the formulations.

The OD concentrate formulations were assessed for emulsification in water

At room temperature, a 5 v/v % solution of the structured system was added to cold water with a hardness of 342 (mg/kg). After 10 gentle rotations of the mixture in a test tube, a good and stable emulsion was obtained. The emulsions remained stable for at least 24 hours following the test.

### APPLICATIONS EXAMPLE 2

This Example illustrates a concentrate, structured using oligomeric structurants, for forming a suspoemulsion on dilution comprising a dispersion of atrazine in an emulsifiable concentrate based on acetochlor as active dissolved in methyl oleate. The formulation was made up using the following components:

| Material | weight % |
|---|---|
| Act4 | 20.0 |
| Act1 | 19.0 |
| Surf1 | 3.51 |
| Surf2 | 0.95 |
| Surf3 | 0.82 |
| Surf4 | 1.32 |
| SE13 | 4.0 (as 25 wt % solution in 2-ethylhexanol) |
| Est2 | 50.4 |

### Preparation Formulation

The formulation was made up as a post-structured formulations as described in Example AE1, by dissolving the acetochlor, surfactants and oligomer (as a 25% solution in 2EH) in the oil and then dispersing the atrazine was dispersed into the thickened emulsifiable concentrate in a Silverson mixer. The Brookfield viscosity (No 3 RVLT Spindle) was determined initially at ambient temperature (ca 20° C.) and after overnight storage at 50° C. and is reported in Table AE2 below.

TABLE AE2

| | |
|---|---|
| temp | Viscosity (mPa · s) |

| Ex No | | (° C.) | 5 (rpm) | 50 (rpm) |
|---|---|---|---|---|
| AE2 | initial | ca 20 | 4700 | 880 |
| | stored | 50 | 2000 | 440 |

The emulsification of the concentrate in water was tested at ambient temperature by adding 5 parts by volume of the structured system to 95 parts by volume of cold water having a standard hardness of 342 ppm. After 10 gentle rotations of the mixture in a test tube, a good and stable emulsion was obtained. The emulsion remained stable for at least 24 hours following the test.

1. An agrochemical concentrate which comprises an agrochemically active component dispersed in a structured oil system which comprises an oil and including as a structurant an oligomer including urethane and/or urea linkages and residues of a dimer or trimer component.

2. A concentrate as claimed in claim 1 wherein the oligomeric structurant includes a dimer component unit of the formula (I):
—(X)-(D)-(X)CO—NH—R¹— (I)
where -(D)- is a difunctional residue which is or includes fatty acid dimer residues; each X is independently —O— or —NH—; and R¹ is a C₁ to C₆₀ hydrocarbylene group.

3. A concentrate as claimed in claim 1 wherein the oligomeric structurant includes repeat units of the formula (Ia):
—(X)-(D)-(X)C(O)NH—R¹—NHC(O)— (Ia)
where -(D)- is a difunctional residue which is or includes fatty acid dimer residues;
each X is independently —O— or —NH—; and
R¹ is a C₁ to C₆₀ hydrocarbylene group.

4. A concentrate as claimed in claim 3 wherein the oligomeric structurant includes urethane repeat units of the formula (Ib):
—O-(D)-OC(O)NH—R¹—NHC(O)— (Ib)
and/or urea repeat units of the formula (Ic):
—NH-(D)-NHC(O)NH—R¹—NHC(O)— (Ic)
where -(D)- is a difunctional residue which is or includes fatty acid dimer residues; and R¹ is a C₁ to C₆₀ hydrocarbylene group.

5. A concentrate as claimed in claim 1 wherein the oligomeric structurant is of the formula (II):
R²—[(X)-(D)-(X)OCNH—R¹—NHCO]ₘ—(X)-(D)-(X)—R² (II)
where R¹, (X) and -(D)- are independently as defined for formula (I);
each R² is independently H,
a group —C(O)R³, where R³ is a hydrocarbyl group, or
a group —C(O)NH—R¹—NHC(O)—(X)—R⁴; or
a group —C(O)NH—R⁴; or
the group —(X)R² is a group —O(AO)ₙ—(CO)ₚR⁴, where each OA is independently an ethyleneoxy or propyleneoxy group, n is from 1 to 50, p is O or 1;
where each R¹ and X are independently as defined above and each R⁴ is independently a hydrocarbyl group; and
m is from 1 to 25.

6. A concentrate as claimed in claim 5 wherein the oligomeric structurant is a polyurethane oligomer of the formula (IIa):
R^{2a}—(X^{a})-[(D^{a})—O₂CNH—R^{1a}—NHCO₂]ₘ₁-(D^{a})-(X^{a})—R^{2a} (IIa), or
a polyurea oligomer of the formula (IIb):
R^{2b}—(X^{b}-[(D^{b})-NHCONH—R^{1b}—NHCONH-]ₘ₂-(D^{b})-(X^{b})—R^{2b} (IIb)
where each R-^{1a} and R^{1b} is independently a C₁ to C₆₀ hydrocarbylene group;
each -(D^{a})- is independently the residue of a diol which is or includes fatty acid dimer diol residues;
each -(D^{b})- is independently the residue of a diamine which is or includes fatty acid dimer diamine residues;
each R^{2a} and each R^{2b} is independently H,
a group —C(O)R³, where R³ is a hydrocarbyl group, or
a group —C(O)NH—R¹—NHC(O)—(X)—R⁴; or
a group —C(O)NH—R⁴;
each X^{a} and each X^{b} is independently —O— or —NH—; and
m1 and m2 are each is an average value of from 2 to 25.

7. A concentrate as claimed in claim 1 wherein the oligomeric structurant includes a trimer component unit of the formula (III):
—(X′)₂-(T)-(X′)CO—NH—R¹⁰— (III)
where -(T)- is a trifunctional residue which is or includes fatty acid trimer residues; each X¹ is independently —O— or —NH—; and R¹⁰ is a C₁ to C₆₀ hydrocarbylene group.

8. A concentrate as claimed in claim 1 wherein the oligomeric structurant includes residues of a trifunctional chain extender.

9. A concentrate as claimed in claim 9 wherein the trifunctional chain extender is trimer acid or a trimer based hydroxyl or amino functional reagent.

10. A concentrate as claimed in claim 1 wherein the concentration of the oligomeric structurant is from 0.2 to 15% by weight of the formulation.

11. A concentrate as claimed in claim 1 wherein the oligomeric structurant includes residues of a non-dimer diol or diamine.

12. A concentrate as claimed in claim 1 wherein the oil is one or more: alcohols, liquid polyols, fatty alcohol polyalkoxylates, ester oils, natural triglycerides, methylated natural triglycerides; aromatic ester oils; branched liquid fatty alcohols; branched liquid fatty acids; hydrocarbons; or a mixture of two or more such types of oil.

13. A concentrate as claimed in claim 1 wherein the agrochemically active component is one or more: plant growth regulator, herbicide, and/or pesticide.

14. A concentrate as claimed in claim 13 wherein the agrochemically active component is one or more: sulfonyl urea herbicides, triazine herbicides, thiocarbamate fungicides, benzenedicarbonitrile fungicides, dicarboximide fungicides, halogenated phthalonitrile fungicides, benzimidazole fungicides, azole fungicides, carbamate insecticides, phenyl organothiophosphate insecticides, cyclodiene insecticides, or a mixture of two or more such types of agrochemically active component.

15. A concentrate as claimed in claim 1 wherein the concentration of the agrochemically active component is from 0.5 to 30% by weight of the formulation.

16. A concentrate as claimed in claim 1 which additionally contains one or more surfactants, solvents, dispersants, electrolytes and/or wetters.

17. A concentrate as claimed in claim 16 wherein the concentration of surfactant is from 5 to 35% by weight of the total formulation.

18. A concentrate as claimed in claim 1 which comprises the following components
a from 10 to 95 wt % of an oil,
b from 0.1 to 15 wt % of oligomeric structurant,
c from 0.5 to 30 wt % of agrochemically active component,
d optionally from 5 to 35 wt % of surfactant,
e optionally from 0.1 to 45 wt % of solvent.

19. A spray formulation which comprises a concentrate as claimed in claim 1, diluted with water.

20. A method of making up a spray formulation which comprises diluting a concentrate as claimed in claim 1 with water.

21. A method of treating vegetation which comprises spraying in which the vegetation or the ground adjacent to vegetation with a spray formulation as claimed in claim 19.
